(19) United States
(12) Patent Application Publication
(10) Pub. No.: US 2006/0068861 A1
(43) Pub. Date: Mar. 30, 2006

(54) Method for presenting content during pauses in an interactive video game

(76) Inventors: Holly Triestram, Okemos, MI (US); Bruce Edward Bower, Lansing, MI (US)

Correspondence Address: HOLLY TRIESTRAM, 4303 TACOMA BLVD., OKEMOS, MI, 48864, US

(21) Appl. No.: 10/955,690

(22) Filed: Sep. 30, 2004

(51) Int. Cl. A63F 13/00

(52) U.S. Cl. 463/1

(57) ABSTRACT

This invention relates to the interactive mechanism for pausing video game data, either from streaming sources or from data embedded on the game and/or media itself. Game systems obtain their content from Compact Disks (CD's), Digital Versatile Disks, (DVD's), cartridges, removable game media, embedded storage, or any other storage media and from servers on the Internet. This may include any method of transmitting or containing game information from wired or wireless remote control devices, Internet sources to the media itself stemming from the game console or personal computer. This invention inserts time-limited generic content into the game play at the moment the pause or the button equivalent to the pause function is engaged, either on the game unit itself, through software on the personal computer, or through devices that control the ability to pause game play. At the moment the pause button is engaged, a control algorithm switches to an alternative content that may come from within the game media itself, a separate and discrete location on media connected to the game unit or from the Internet.

### BACKGROUND OF THE INVENTION

This invention relates to the interactive mechanism for pausing video game data, either from streaming sources or from data embedded on the media itself. This could include any method of transmitting or containing game information from wired or wireless Internet sources to the media itself stemming from the game console or personal computer.

Current game players press the pause key to stop the game when they want to temporally pause/stop the game in progress. Our invention takes advantage of this pause to insert advertising or other content to the paused screen. Instead of seeing the frozen last still image on the screen, the game player(s) would see this new content. Unlike other systems, our intent is to not restrict the user from fast-forwarding through our content or re-enabling the game by pressing the “play” button. Our purpose is to insert and inject a still image or short animation or video that would loop during the duration that the pause button was pressed.

The common denominator would be pausing of the game to insert content contextually sensitive to the paused “in game” content and delivering a message that can be either embedded in the game delivery medium itself (CD-ROM, DVD and/or “DVD like” media of the future, wired or wireless streaming from the broader Internet to dedicated servers from local Internet Service Providers [ISP's], or from satellite or any external source). The information may be from the time of the game creation itself to the latest up-to-the-minute streamed or updated content.

### PRIOR ART

### DIFFERENCES BETWEEN THIS PAUSING INVENTION AND PRIOR INVENTIONS

This invention differs substantially from other inventions of real-time video pausing mechanisms (TiVo and RePlay), in that it does not record or store either locally or remotely the real-time video content that was playing in the background. Secondly, TiVo and RePlay and other interactive media pausing inventions all refer to real-time media, video-on-demand media, near video-on-demand media that are dependent on a distribution facility for content that is pushed to the consumer and do not include game consoles and other such game devices such as Personal Computers, wireless phones, handheld gaming systems and other game devices not yet invented but service this category. Third, our invention is not in the same category as it refers to pausing games and not video and/or film being broadcast by a television company, cable company, or satellite company or even Internet based video delivery service based delivery methods. Fourth, other prior art depends on using Internet servers to push the content to viewers of TiVo and RePlay video and near video-on-demand customers during a pause in the movie, film, television show. Our focus is on personal gaming systems, dedicated arcade gaming systems, handheld gaming systems, Personal Computers, cellular telephone, pagers and/or any compatible gaming unit that accepts programming to pause the game currently in play. Our invention will use both embedded messages pre-recorded in the game itself, in the game storage media (CD-ROM, DVD, cartridge or other media) and advertisers own distributed servers to deliver the message after pressing the pause button.

Our invention refers to what happens when the game player presses on the “Pause” key and is delivered a message from the game developer, advertiser, or other source. The current behavior of the “pause button” in Personal Computer, Console, Handheld gaming systems and games embedded in telephones, is the dimming of the screen and/or a freezing of the game play at that moment with a static image or a blank screen. Our invention begins with the pressing of the pause key. The most relevant prior art (ID # 584507) patent begins when the player uses a mouse to select specific “hot spots” on the screen that then links with an external purchasing option.

Our invention is the development of a control mechanism to read the console or other game device, operating system, and its capabilities, and then display content appropriate to that device.

This invention would use established developer handshaking protocols often proprietary to each game system but that allow developers and third-party programmers access to their game system. The timeliness of the content will be refreshed from accessing either the clock feature built into the mechanism, accessing external time clocks, Universal Resource Locator's (URL's), programs downloaded to the device that would on a pre-programmed cue or by date/time update the device. This would permit a synchronization of devices and content to deliver the message and the message could be updated continuously by whatever criteria the game developer or advertiser desired. For example, the person completes a level in a game and upon this cue, the next time the person presses the “pause key”, they receive a personalized message and tip for playing the next level. Any number of commercial applications can be derived from inserting data in the pausing sequence in games.

### OBJECTS AND ADVANTAGES

This invention elevates the gaming experience by permitting players and advertisers to interact during otherwise dull, static and non-interactive “pauses” in the game play. Players will receive tailored, real or pre-recorded messages/offers of any kind related to playing the game. The types of content are essentially unlimited as the advertisers devise the content and decide whether it should be tailored to a game player's specific spot in the game or a general offer of whatever kind they want.

The developers envision coupon codes for future game discounts, mini-video/animation/still advertisements for current or future games, tips and tricks and hints for where the player is “in the game” at that moment. A breathtaking glimpse of how this could be interactive is if the player interacts in “real time” with another player, server, or any other form of external message delivery system and has a two way dialogue.

To expand on the sources of the “pause time content”, we envision the content for the pause interval would come from the game distributed media itself, whether CD-ROM, DVD, or any future storage media itself, the dedicated game engine and its' components, the Internet, cable company, telephone company, Internet Service Provider (ISP), media and/or entertainment company, distributed servers, and/or by set intervals or by subscription.

In another future utilization of this invention. We believe that paid subscriptions to Internet based servers would download or be available “on demand” to push new content to the game playing individual during the moments when the game is paused. This would maintain a steady cash flow for the licensees of this invention from advertisers or the game developer, distributor or other agency licensing the invention.

Examples of subscription programs available would be to allow the game player(s) special privileges earn points, credits, money, play in contests, and receive customized information via the Internet, telephone, cable, satellite or by embedded technology.

### SUMMARY

This invention relates to the interactive mechanism for inserting into the interval of time immediately after the game is put into a “pause” or “on-hold” of the ongoing game plays. The sources of this content can be from a mixture of data from the game storage media itself, (such as a CD-ROM/DVD or game cartridge), from streaming LAN or WAN inter/intranet sources, and from data embedded in the device itself. This invention inserts time-limited generic content into the game play at the moment the pause button is engaged and game play frozen or suspended, either on the game unit itself, through software on the personal computer, or through devices that control the ability to pause game play. At the moment the pause button is engaged, a control algorithm switches to an alternative content that may come from within the game media itself, a separate and discrete location on media connected to the game unit or from the Internet.

### DRAWINGS

1. Description of FIGS. 1a/b

FIGS. 1a and 1b illustrate both a typical console system (the Game Cube) and the personal computer being used as a game system, respectively. The patent application applies to other gaming consoles and devices that play games and permit the use of the pause command function.

2. Description of FIGS. 2a/b

Description of FIGS. 2a and 2b illustrate typical remote controls, wired and wireless, used to send the command functions such as stop, play, pause, resume, angle, subtitles, and all the other commands available on today's remote controls.

3. Description of FIGS. 1a/b

FIGS. 1a and 1b illustrate both a typical console system (the Game Cube) and the personal computer being used as a game system, respectively. The patent application applies to other gaming consoles and devices that play games and permit the use of the pause command function.

4. Description of FIGS. 2a/b

Description of FIGS. 2a and 2b illustrate typical remote controls, wired and wireless, used to send the command functions such as stop, play, pause, resume, angle, subtitles, and all the other commands available on today's remote controls

### DETAILED DESCRIPTION OF PREFERRED EMBODIMENTS

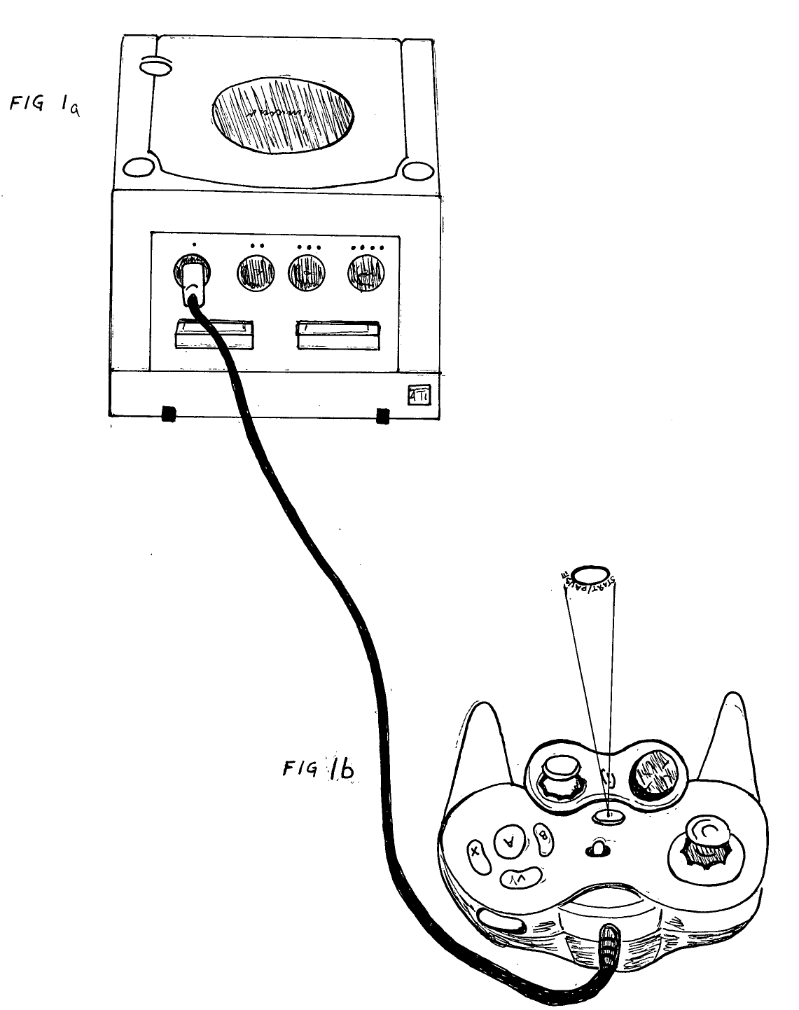

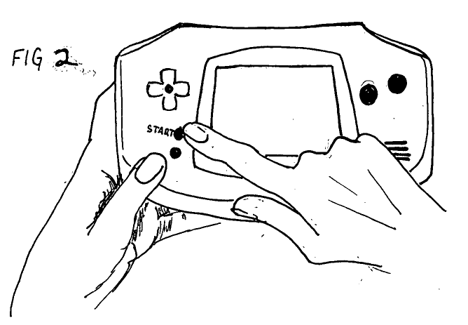

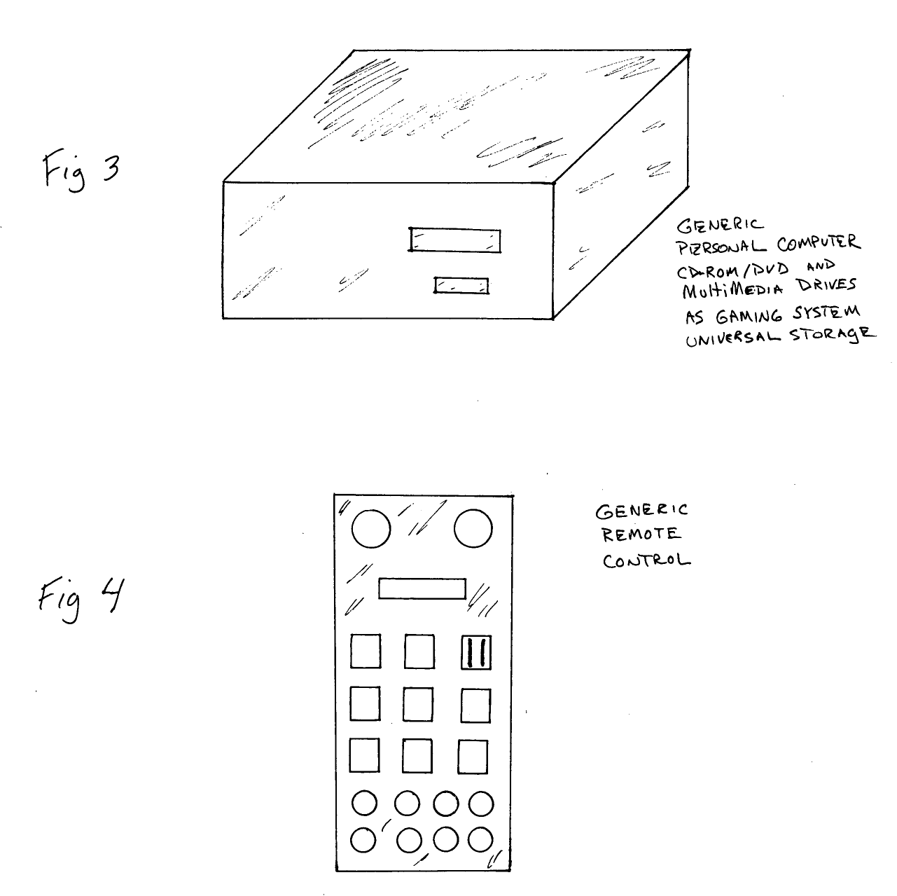

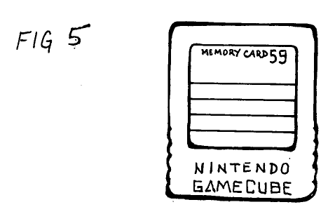

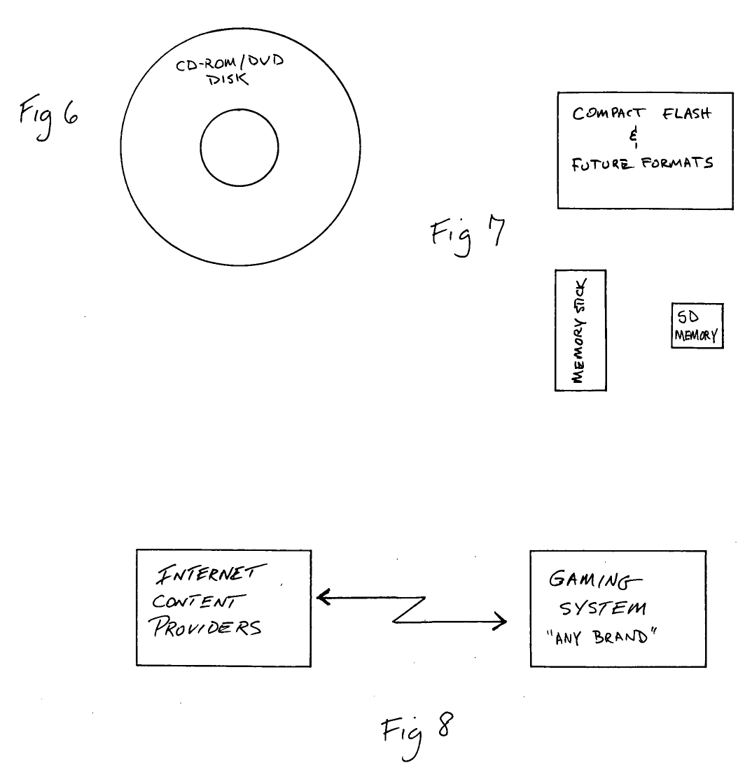

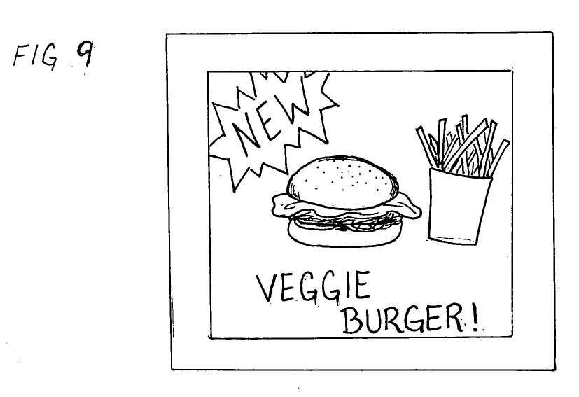

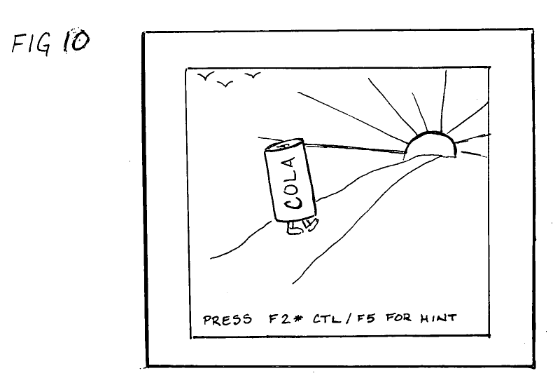

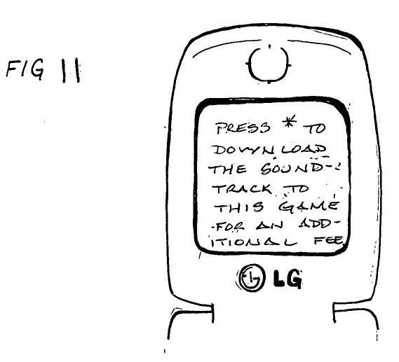

FIGS. 1a/b illustrates a typical game system (xBox, Game Cube, GameBoy Advance, Personal Computer, cellular telephone). All current and projected gaming devices have a method through keystrokes, on-screen display or a dedicated button, for pausing the game.

FIG. 2b illustrates a generic remote control with the pause button and the universal symbol for pause, the two upward facing vertical bars.

Game storage media is constantly changing but the underlying principle of pausing a game is a universal requirement of the gaming experience. Currently, game are distributed by media transmission systems and media such as the Internet (FIG. 3), game media (FIG. 4), CD-ROM (FIG. 5), DVD type media (FIG. 6) and finally, embedded in the unit itself (for example in many cellular telephones).

Advertisers and/or marketers would contract with the game developer to produce marketing materials that play their message immediately following a player's pushing of the “pause” button. (Whatever the pause command key is on the specific device or system). See FIGS. 8-9 for examples.

If the game console is connected to the Internet (FIG. 3), then the message may come from the advertiser's server or other distribution center.

Similarly, if available, the game device will communicate back to the advertiser that the pause button has been pushed at this point in the game 7 and that specialized, context sensitive material may be activated and retrieved from the local game storage devices, a wireless or cellular connection, and from the Internet.

The game pause data will come from all known and future technologies that permit communication between devices. Both analog and digital, all known wired and in development wired and wireless cabling and data transmission technologies.

The game player may interact with the game system via control circuitry that initiates an operating system control code to freeze the program running the game. We commonly call this “pausing the game” and internally the game device or program stops the game program from continuing while waiting for a control signal to either perform any number of commands. Those commands often include stopping the game completely, pausing the game, stepping backward or forward to another point in the game, capturing a portion of the screen to memory, playing an alternative language or audio soundtrack, changing game parameters, changing game subtype, changing character, changing what and how it can communicate to other devices. The list of available commands is essentially endless as this is a programming function and the game story line may dictate the available commands.

In one suitable embodiment, the developer of the game itself will self-promote their other games by inserting advertisements for their other games building in the ability to show animated clips of other games during the time the pause button was engaged.

In addition, the game itself could be upgraded or updated if so desired if that functionality was in that specific game system.

After receiving the command to come out of the “pause” mode, the game play will pick up where it was previously paused. This command may be specific to each game device but is usually pressing the “play” button, the “pause” button again or pressing a directional key that activates a “resume play” function, or a on-screen representation of the play function, such as in a icon with a right facing diamond shape, the universal symbol for play.

Embedded in the command codes to initiate the playing of content when the pause key is pressed, could be mini-programs and/or applets that harvest the game playing habits of the game players device, such as different users, games played, points in the game when the game was paused, and feedback on how long the pause related content was allowed to play before the player resumed playing the game. Since the purpose of mini-programs in embedded systems or Personal Computers is to track usage and user habits, this could be valuable information for the game company, developers and advertisers.

This invention is not dependent on a distribution facility as mentioned, but like the Internet itself may have thousands of advertisers who purchase the privilege of pushing content to consumers while they are playing games.

In another embodiment the various authors, game developers, distributors, Internet Service Providers (ISP's), third-party advertisers, storage media producers and private organizations and individuals, permanently embed into the media itself (for example a DVD), the media that is played during the pause interval. No connection to the Internet is necessary with this device and with this scenario as the advertisers have multiple sources for to draw on to play back their message.

In a further embodiment, the game player would be able to partially or completely program and alter a portion of the pause related media. So for example, they might press the pause key but instead of generic music associated with the advertiser's product, they hear something they like but watch the visual portion of the advertiser's product. This ability to listen to their music gives great user satisfaction and actually enhances the acceptance of the other portion of the advertiser's message as the music is now associated with that product and/or message.

It is understood that this is not an exhaustive list of embodiments as that would be impossible as the nature of all third-party content would be unknown and therefore limitless. We just don't know all the uses creative individuals could think for how to use this invention.

### OPERATION, DESCRIPTION, CONCLUSION, RAMIFICATIONS & SCOPE OF INVENTION

Game Player will engage the game system (FIGS. 1a/b) to initiate the start of what is commonly known as a “video game”. Video games are commonly composed of programmed content, animation, still graphics, motion video, interactivity with other players and/or single player mode, and we propose, advertising content that will be played when the game player pushes the “pause button” or the game pauses for whatever reason without interfering with the game play itself. FIG. 2b illustrates a generic remote control and the associated “Pause” key on its' keypad. FIG. 3 illustrates a typical computer screen with a facsimile of a remote control and its' “Pause” key. FIG. 1a illustrates the “Pause” key on smaller remote game playing devices such as “handheld” game systems and cellular telephones that have embedded or downloadable games.

FIGS. 4-6 illustrate storage media currently in common usage to store the content. FIG. 4 a typical generic computer based storage media. FIG. 5 is a CD-ROM media. FIG. 6 a DVD. FIG. 7 a typical generic game cartridge storage media. This is illustrative of the ever changing but universal need for some form of non-Internet based storage media.

FIGS. 1a/b illustrates how the game console unit will communicate with the game remote control and its' own storage media.

FIG. 3 illustrates how the game console unit will communicate with Internet based servers (FIG. 10), to download real time, often contextually relevant messages to the game player during a video game's pause interval.

FIG. 8 shows the game console screen with a typical advertiser message.

FIG. 9 shows a typical Personal Computer's screen with a Hint message that is contextually relevant to the game play at the point where the player is in the game.

FIG. 10 shows a typical cellular telephone screen and an offer from the telephone carrier for a special ring tones licensed from the game being played.

The gaming industry is becoming embedded in all devices that we carry or have in our homes. From gaming console systems, televisions, Personal Computers, Personal Video Records (PVR's), to “smart” handheld devices like pagers and cellular telephones.

There currently is not an invention for utilizing the lost time that occurs when a person playing a game pushes the “pause” and/or “hold” buttons to suspend game play. Our invention is new as it takes advantage of this valuable time and exploits it for increasing the utility of this “paused time interval” for any number of commercial or entertainment reasons.

1. A method of substituting content in a game system or device or gaming operating system following pressing the pause button.

2. The content or media played during the pause interval may come from static or dynamic sources, embedded, interactive, or streaming.

3. That the equipment and/or software will be able to play, pause and resume playing and be able to accept an alternate data source of information for display on the screen.

4-20. (canceled)
